(19) United States
(12) Patent Application Publication
(10) Pub. No.: US 2023/0373187 A1
(43) Pub. Date: Nov. 23, 2023

(54) BIO-BASED WATERPROOF BREATHABLE MEMBRANES AND ARTICLES

(71) Applicant: Allbirds Inc., San Francisco, CA (US)

(72) Inventor: Thomas Jad Finck, San Francisco, CA (US)

(21) Appl. No.: 18/114,009

(22) Filed: Feb. 24, 2023

Related U.S. Application Data
(60) Provisional application No. 63/314,229, filed on Feb. 25, 2022.

(51) Int. Cl. B32B 5/24; B32B 7/12

(52) U.S. Cl. CPC B32B 5/245; B32B 7/12; B32B 2250/03; B32B 2250/40; B32B 2262/0261; B32B 2266/025; B32B 2305/026; B32B 2307/7265

(57) ABSTRACT

Bio-based porous membranes having waterproof and breathable properties are disclosed. The bio-based membranes may be free of PFCs. Laminates and articles including the bio-based membranes, as well as methods for making the bio-based membranes, are also disclosed.

### CROSS-REFERENCE TO RELATED APPLICATION(S)

This application is a nonprovisional patent application of and claims the benefit of U.S. Provisional Patent Application No. 63/314,229, filed Feb. 25, 2022 and titled “Bio-Based Waterproof Breathable Membranes and Articles,” the disclosure of which is hereby incorporated herein by reference in its entirety.

### FIELD

The described embodiments relate generally to bio-based waterproof breathable membranes and articles. More particularly, the present embodiments relate to bio-based porous membranes, articles including these membranes, and processes for making these membranes.

### BACKGROUND

Some traditional waterproof breathable membranes are derived from petroleum oil. These membranes include porous membranes and as well as monolithic membranes which are free of pores. One example of a traditional waterproof breathable membrane is an expanded polytetrafluoroethylene (PTFE) membrane.

### SUMMARY

The disclosure provides bio-based porous membranes that can be both waterproof and breathable. The disclosure also provides laminates including the bio-based porous membranes and articles including the laminates. Methods for manufacturing the porous membranes are also provided.

The bio-based porous membranes disclosed herein can provide waterproof breathable membranes which are more environmentally sustainable than traditional petroleum-based breathable membranes. In some examples, the micro-porous membranes disclosed herein can include one or more polymer materials derived from a renewable source. Examples of renewable sources include, but are not limited to, sugarcane, sugar beet, starch crops, trees, bamboo, and the like. In additional examples, the micro-porous membranes may be formed wholly from bio-based polymer materials.

In addition, the bio-based porous membranes may be substantially free of per- and poly-fluorinated compounds (PFCs). For example, the porous membranes described herein can be formed from non-fluorinated polymer materials. In some cases, the porous membranes are formed from a non-fluorinated polyolefin material such as non-fluorinated polyethylene material.

The disclosure also provides laminates including a bio-based porous membrane. The laminate may include one or more layers in addition to the bio-based porous membrane. For example, the laminate may include the bio-based porous membrane as a first layer and a second layer that is a textile layer, a leather layer, or a polymer layer. In some cases, the laminate may include one or more bio-based membranes between two other layers, such as two textile layers. A first textile layer defining an outer surface of the laminate may have one or more properties which differ from those of a second textile layer defining an inner surface of the laminate, as is discussed in more detail below. The laminate may further include a bio-based water repellant agent applied to its outer surface.

The disclosure further provides articles including bio-based porous membranes. For example, the article may be an article of apparel such as a shoe, a jacket, a pair of pants, a glove, or the like. The article may include a laminate as described herein. For example, the article may include one or more bio-based membranes between a first textile layer that defines an outer surface of the article and a second textile layer that defines an inner surface of the article. In some cases, the first textile layer may be more durable than the second textile layer. The article may further include a bio-based water repellant agent applied to its outer surface. This bio-based water repellant agent may also be PFC free.

The disclosure also provides methods for manufacturing bio-based porous membranes. The porous membranes may be produced from a polymer composition having a specified bio-based carbon content. The polymer composition may comprise a polyolefin material such as a polyethylene material. In some examples, the polyethylene material has a bio-based carbon content of 90% or more. In some cases, the methods include an operation of producing a sheet from the polymer composition and an operation of stretching the sheet to form the bio-based porous membrane.

The disclosure provides a porous membrane having a bio-based carbon content greater than 50% and including a polyolefin material.

The disclosure also provides a laminate having a bio-based carbon content greater than 50%. The laminate comprises, as a first layer, a porous membrane having a bio-based carbon content greater than 50% and including a polyolefin material. The laminate further comprises a second layer, different from the first layer. In addition, the disclosure provides an article of apparel comprising the laminate.

The disclosure further provides a method for manufacturing a bio-based porous membrane, the method comprising producing a sheet from a polymer composition having a bio-based carbon content greater than 50% and including a polyolefin material. The method further comprises stretching the sheet to form the bio-based porous membrane.

### BRIEF DESCRIPTION OF THE DRAWINGS

The disclosure will be readily understood by the following detailed description in conjunction with the accompanying drawings, wherein like reference numerals designate like elements.

FIG. 1 shows a magnified top view of a sample bio-based porous membrane.

FIG. 2 shows a cross-sectional view of a laminate including a bio-based porous membrane.

FIG. 3 shows a cross-sectional view of another laminate including a bio-based porous membrane

FIG. 4 shows an example of a shoe including a bio-based porous membrane.

FIG. 5 shows another example of a shoe including a bio-based porous membrane.

FIG. 6 shows an example of a jacket including a bio-based porous membrane.

FIG. 7 shows a flow chart of an example process for making a bio-based porous membrane.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

The disclosure provides bio-based porous membranes that can be both waterproof and breathable. The disclosure also provides laminates including the bio-based porous membranes and articles including the laminates. Methods for manufacturing the porous membranes are also provided.

The bio-based porous membranes disclosed herein can be used as waterproof breathable membranes which are more environmentally sustainable than traditional petroleum-based breathable membranes. In some embodiments, the micro-porous membranes disclosed herein can include one or more polymer materials derived from a renewable source. Examples of renewable sources include, but are not limited to, sugarcane, sugar beets, starch crops, trees, bamboo, and the like. Use of renewable sources such as sugarcane to produce polymer materials can also provide environmental benefits with respect to carbon dioxide (CO₂) capture, which can help reduce harmful greenhouse gas levels. For example, each ton of polyethylene derived from sugarcane can capture and fix up to 3 tons of CO₂. In additional embodiments, the micro-porous membranes may be formed wholly from bio-based polymer materials.

In addition, the bio-based porous membranes may be substantially free of per- and poly-fluorinated compounds (PFCs). For example, the porous membranes described herein can be formed from non-fluorinated polymer materials. In some cases, the porous membranes are formed from non-fluorinated polyolefin materials such as polyethylene, polypropylene, and the like. Using non-fluorinated polymers to make the bio-based porous membranes can avoid any environmental impacts due to the fluorinated compounds used in making fluorinated polymers.

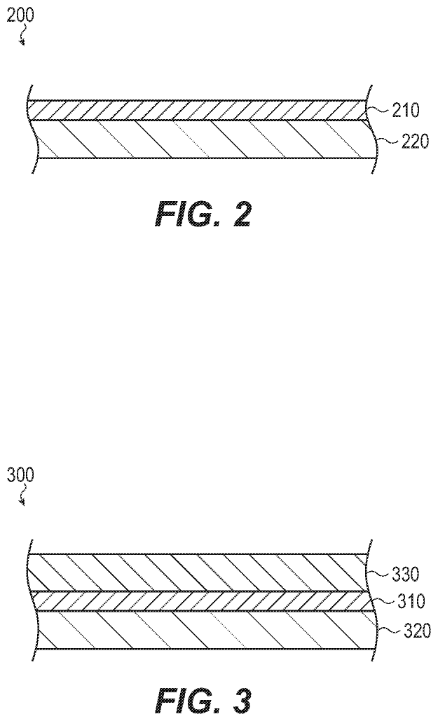

The disclosure also provides laminates including a bio-based porous membrane. The laminate may include one or more layers in addition to the bio-based porous membrane. For example, the laminate may include the bio-based porous membrane as a first layer and a second layer that is another bio-based layer. The other bio-based layer may be textile layer, a leather layer, a polymer layer, or a combination of these. In some embodiments, the laminate may include one or more bio-based membrane layers between two other layers, such as a first and a second textile layer. A first textile layer defining an outer surface of the laminate may have one or more properties which differ from those of a second textile layer defining an inner surface of the laminate. For example, the first textile layer may be more durable than the second textile layer, while the second textile layer may be softer than the first textile layer. The additional description of suitable textile layers provided with respect to FIG. 2 is generally applicable herein and is not repeated here. The laminate may further include a bio-based water repellant agent applied to its outer surface.

The disclosure further provides articles including bio-based porous membranes. For example, an article may be an article of apparel such as a shoe, a jacket, a pair of pants, a glove, or the like. The article may include a laminate comprising the bio-based porous membrane. For example, the article may include one or more bio-based membranes between a first textile layer that defines an outer surface of the article and a second textile layer that defines an inner surface of the article. The article may further include a bio-based water repellant agent applied to its outer surface. In some embodiments, this bio-based water repellant agent is PFC free and, in some cases, may be in the form of a coating. Using bio-based water repellant agents that are PFC-free can avoid any environmental impacts due to by-products from fluorinated water repellant agents.

The disclosure also provides methods for manufacturing bio-based porous membranes. The bio-based porous membranes may be produced from a bio-based polymer composition having a specified bio-based carbon content. The polymer composition may comprise a polyolefin material such as a polyethylene material. In some examples, the polyethylene material has a bio-based carbon content of 90% or more. In some cases, the methods include an operation of producing a sheet from the polymer composition and an operation of stretching the sheet to form the bio-based porous membrane.

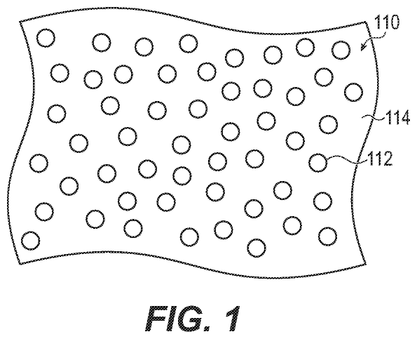

These and other embodiments are discussed below with reference to FIGS. 1-7. However, those skilled in the art will readily appreciate that the detailed description given herein with respect to these figures is for explanatory purposes only and should not be construed as limiting.

FIG. 1 shows a magnified top view of a bio-based porous membrane. As schematically indicated in FIG. 1, the bio-based porous membrane 110 comprises a plurality of pores 112, which have been enlarged in FIG. 1 for ease of illustration. The pores 112 may be configured to limit or prevent the passage of liquid water through the membrane so that the bio-based porous membrane 110 has a waterproof property. For example, the pores 112 may have an average pore size that is too small to allow ready passage of droplets of water through the membrane. The pores 112 may also be configured to allow passage of water vapor through the membrane, so that the bio-based porous membrane has “breathability.” For example, the pores may have an average pore size that is large enough to allow passage of water molecules in the vapor phase to pass through the membrane. The bio-based porous membrane 110 may be thin and in some examples may have a thickness greater than 10 micrometers and less than 500 micrometers, less than 250 micrometers, less than 100 micrometers, or less than 50 micrometers.

In embodiments, the bio-based porous membrane 110 is a microporous membrane. In some examples, the pores 112 of the microporous membrane have an average pore size of 1 micrometer or less, such as from 10 nanometers to 1 micrometer. For ease of illustration, the pores 112 of FIG. 1 are shown as forming distinct, generally circular openings of uniform size at the top surface 114 of the bio-based porous membrane. More generally the pores 112 may vary in size and may define openings at the surfaces of the membrane that have other shapes, such as a rounded shape other than a circular shape or an irregular shape. In addition, the pores 112 may form an interconnected network of channels within the bio-based porous membrane. The bio-based porous membrane may have a porosity level that provides the desired water vapor transport properties while maintaining structural integrity. In some cases, the porosity level is 40% or more, 50% or more, or 60% or more and may have an upper limit of 80%, 90%, or 95%.

The bio-based porous membrane may be formed from a bio-based polymer composition. As referred to herein, a bio-based product is wholly or partly derived from materials of biological origin (excluding materials that are embedded in geological formations and/or fossilized). In some cases, the bio-based products described herein relate to or are made from renewable carbon-based biological sources such as agricultural or forest materials. Examples of renewable carbon-based biological sources (also referred to as feedstocks) include, but are not limited to, sugarcane, sugar beets, starch crops, trees, bamboo, and the like. As previously discussed, use of renewable sources such as sugarcane to produce polymer materials can also provide environmental benefits with respect to carbon dioxide (CO₂) capture, which can help reduce harmful greenhouse gas levels.

The bio-based carbon content provides one measure of the bio-based content of a carbon-containing product and is determined from the ratio of “new” organic carbon (e.g., plant or agricultural-based carbon) to the total organic carbon in the product. The bio-based carbon content may be determined using a standardized method such those described in ASTM D6866, ISO 16620-2, and CEN 16640. In some cases, the bio-based carbon content of the bio-based porous membrane is as high as 85% to 100%, 90% to 100%, or 95% to 100%. In additional cases, the bio-based porous membrane may have a bio-based carbon content greater than 50%, from 60% to 100%, from 60% to 95%, from 70% to 100%, from 70% to 95%, from 80% to 100%, or from 80% to 95%.

The bio-based polymer composition may comprise one or more bio-based polymer materials, which may also be referred to herein as bio-based resins. The bio-based polymer composition may be a thermoplastic composition. In some cases, the bio-based polymer material is a bio-based polyolefin material. As examples, the bio-based polyolefin material may be a polyethylene material or a polypropylene material. In embodiments, the bio-based polyethylene material is a high molecular weight polyethylene (HMWPE) material or an ultrahigh molecular weight polyethylene material (UHMWPE) (e.g., as determined by weight average molecular weight or number average molecular weight). In additional embodiments, the bio-based polyethylene material is a high-density polyethylene (HDPE) material, a low-density polyethylene material (LDPE), or a low linear density polyethylene (LLDPE). In some cases, the bio-based carbon content of the bio-based polyethylene material is as high as 85% to 100%, 90% to 100%, or 95% to 100%. In additional cases, the bio-based polyethylene material may have a bio-based carbon content greater than 50%, from 60% to 100%, from 60% to 95%, from 70% to 100%, from 70% to 95%, from 80% to 100%, or from 80% to 95%.

In some cases, the bio-based polyethylene material may be formed from a single polyethylene resin or from a blend of polyethylene resins having different molecular weight ranges and/or chemical structures. In additional cases, the polyolefin material may include a mixture of different polyolefin materials and/or additives such as fine particles. In some examples, the amount of additives may be less than 10% so that the polyolefin material makes up at least 90% of the bio-based polymer composition (e.g., as weight percentages). In further cases, the bio-based polymer composition may include a mixture of a bio-based polyolefin polymer with another class of bio-based polymer.

In some embodiments, the bio-based polymer composition may be substantially free of per- and poly-fluorinated compounds (PFCs). For example, only non-fluorinated polymer materials may be included in the bio-based polymer composition. As a result, the bio-based membrane may be free of PFCs and have a reduced environmental impact as compared to a fluorinated membrane.

In some cases, the bio-based porous membrane defines one layer of a laminate. As shown in the cross-sectional view of FIG. 2, the laminate 200 includes a bio-based porous membrane 210 coupled to another layer 220. The relative thicknesses of the bio-based porous membrane 210 and the layer 220 shown in FIG. 2 are magnified for ease of illustration and are exemplary rather than limiting.

In some examples, the layer 220 is bio-based. For example, the layer 220 may be a bio-based textile layer, a leather layer, a bio-based polymer layer, or a combination of these. In some cases, a bio-based textile layer may comprise a bio-based nylon, such as a bio-based polyamide 10-10 or a bio-based polyamide 11. In embodiments, a textile layer, such as a bio-based textile layer, may be a woven textile layer, a knitted textile layer, or a non-woven textile layer.

In some cases, the layer 220 may define an outer surface of an article such as an article of apparel. In some examples, a layer 220 defining the outer surface of the article may be formed of a one or more of a bio-based textile layer, a leather layer, or a bio-based polymer layer. When the layer 220 defines the outer surface of the article, the layer may be formed from woven textile such as a woven bio-based nylon textile. A bio-based water repellant agent may be applied to an outer surface of the layer 220 when the layer 220 defines the outer surface of the article. This bio-based water repellant agent, which may also be referred to herein as a durable water repellant agent (DWR), may be non-fluorinated and PFC free.

In additional cases, the layer 220 may provide a protective lining for the bio-based porous membrane 210. In some examples when the layer 220 provides a protective lining, the layer 220 may be formed of a bio-based textile or a bio-based polymer. In some cases, a layer that provides a protective lining at an inner surface of the article may be softer and/or less durable than a layer that defines an outer surface of the article. For example, a layer that provides a protective lining may be formed of a knitted textile such as tricot or another suitable textile.

The bio-based porous membrane 210 may be coupled to the layer 220 using an adhesive, heat bonding, or a similar method. In some cases, the adhesive may be a bio-based adhesive. For example, the bio-based adhesive may include one or more of a bio-based nylon or a bio-based thermoplastic polyurethane. The bio-based adhesive may be applied as a continuous layer or as discrete elements (e.g., dots or lines).

As shown in the cross-sectional view of FIG. 3, the laminate 300 includes a bio-based porous membrane 310 positioned between two other layers 320 and 330. The relative thicknesses of the bio-based porous membrane 310 and the layers 320 and 330 shown in the cross-sectional view of FIG. 3 are exemplary rather than limiting.

In some cases, one of the layers 320 and 330 forms an outer layer of the laminate 300 and the other of the layers 320 and 330 forms an inner layer of the laminate. The layer forming the inner layer of the laminate 300 may provide a protective inner lining for the bio-based porous membrane. The layer forming the outer layer of the laminate may define an outer surface of an article and or may simply form a protective outer layer for the bio-based porous membrane. The layers 320 and 330 may be formed of similar materials as previously described with respect to the layer 220. The layers 320 and 330 may also be coupled to the bio-based porous membrane 310 as previously described with respect to the layer 220.

In embodiments, the laminates such as the laminates 200 and 300 are bio-based due to the inclusion of one or more bio-based-layers in the laminate. In some examples, the laminates 200 and 300 include multiple bio-based layers as well as a bio-based adhesive. As a whole, the laminate may have a bio-based carbon content of at least 25%, at least 50%, from 60% to 100%, from 60% to 95%, from 70% to 100%, from 70% to 95%, from 80% to 100%, from 80% to 95%, from 85% to 100%, or from 90% to 100%.

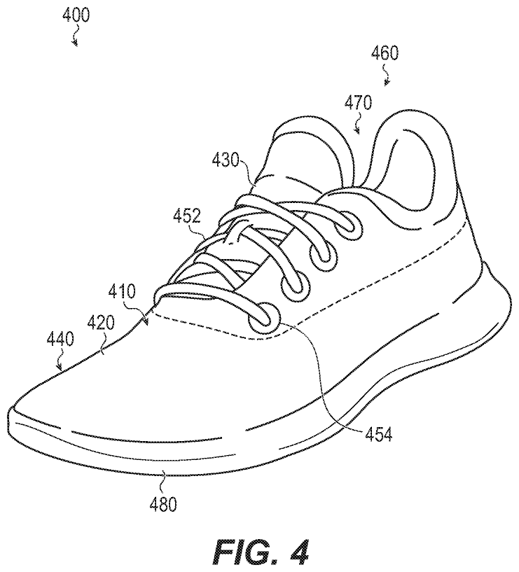

The disclosure further provides articles including bio-based porous membranes. For example, the article may be an article of apparel such as a shoe, a jacket, a pair of pants, a glove, a gaiter, or the like. FIG. 4 shows an example of a shoe that includes a bio-based porous membrane. As an additional example, the article may also be an accessory article such as a tote bag, a handbag, or a drawstring bag. As a further example, the article may be a household good or an outdoor equipment article.

In the example of FIG. 4, the shoe 400 has upper portion 440 that includes one or more bio-based porous membranes as described herein. As shown in FIG. 4, the upper portion 440 of the shoe 400 includes a membrane portion 410, an upper boundary of which is indicated by a dashed line. The membrane portion 410 can improve the water resistance of the shoe 400 and includes at least one bio-based porous membrane as previously described. In some cases, a lower boundary of the membrane portion may extend to or past a junction between the upper 440 and the sole 480. In the example of FIG. 4, the upper boundary of the membrane portion 410 is positioned below the opening 470 of the shoe, but this example is not limiting and in additional examples the membrane portion may extend to the opening of the shoe.

The upper portion 440 also includes an outer layer 420, which in some cases is a textile layer. The bio-based porous membrane in the membrane portion 410 may be laminated to the outer layer 420 a similar fashion as previously described with respect to the laminates 200 and 300. In some examples, the bio-based porous membrane is positioned between the outer layer 420 and an inner layer that serves as a lining for the shoe.

The sole 480 of the shoe 400 defines a tread surface that is adapted to contact the ground or other surfaces while the shoe is worn. The sole 480 may be attached to the upper portion 480, for example using an adhesive. In some cases, the sole may include a bio-based material, such as a bio-based foam. For example, the sole may include a foam formed from a bio-based ethylene vinyl acetate (EVA) or a bio-based polyurethane. The shoe 400 may also include an insole positioned in the cavity and in some cases, the insole may include one or more bio-based materials. For example, the insole may include a foam formed from a bio-based ethylene vinyl acetate (EVA) or a bio-based polyurethane.

The shoe 400 also includes a tongue 430 and the tongue 430 and the upper 440 cooperate to define an opening 470 to a cavity 460 of the shoe. The shoe also includes laces 452 and eyelets 454 that can help retain the shoe 400 to a wearer's foot. In some cases, the eyelets 454 may be formed from a bio-based material.

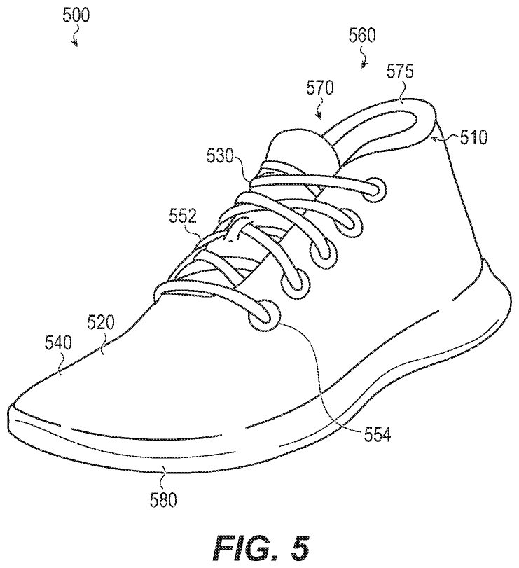

FIG. 5 shows another example of a shoe. The shoe 500 has upper portion 540 that includes one or more bio-based porous membranes as described herein. In the example of FIG. 5, the shoe 500 is configured as a mid-top or high-top shoe, which may also be referred to herein as a short boot or “bootie.”

As shown in FIG. 5, the upper portion 540 of the shoe 500 includes a membrane portion 510 that extends to a collar 575 that surrounds an opening 570 to the cavity 560. The membrane portion 510 can improve the water resistance of the shoe 500 and includes at least one bio-based porous membrane as previously described. In some cases, a lower boundary of the membrane portion may extend to or past a junction between the upper 540 and the sole 580. In the example of FIG. 5, the upper boundary of the membrane portion 510 is positioned at or near the collar 575 of the shoe, but this example is not limiting and in additional examples the membrane portion may extend to a lower height along a wall of the shoe. In some cases, the membrane portion may also include all or part of the tongue 530.

The upper portion 540 also includes an outer layer 520, which in some cases is a textile layer. The bio-based porous membrane in the membrane portion 510 may be laminated to the outer layer 520 a similar fashion as previously described with respect to the laminates 200 and 300. In some examples, the bio-based porous membrane is positioned between the outer layer 520 and an inner layer that serves as a lining for the shoe.

The shoe 500 also includes a tongue 530. In some cases, the tongue 530 may be a gusseted tongue. As previously mentioned, the tongue 530 may be included in the membrane area 510 in some cases. The shoe also includes a sole 580, eyelets 554, and laces 552 which may have the same or similar structure and functionality as described with respect to the sole 480, the eyelets 454, and the laces 452 of the shoe 400.

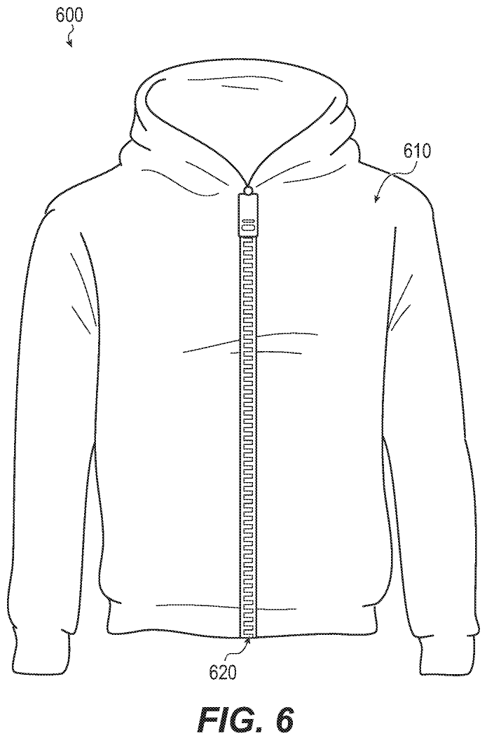

FIG. 6 shows an example of a jacket 600 that includes one or more bio-based porous membranes as described herein. The jacket 600 may have a water-resistant or waterproof property imparted by the one or more bio-based porous membranes. In some cases, the jacket 600 may be a hard-shell jacket while in other cases the jacket 600 may be a hybrid jacket.

In the example of FIG. 6, the jacket 600 includes a membrane portion 610. In some embodiments, the membrane portion 610 may extend over most of the jacket, such as 75%, 80%, 90%, or more of the surface area defined by the jacket. In additional embodiments, the membrane portion may extend over a lesser area of the jacket to allow for greater ventilation in one or more regions of the jacket, such as a region positioned under the arm of a wearer.

In the example of FIG. 6, the jacket includes a zipper 620. The zipper 620 is shown in FIG. 6 as a full-length zipper. However, in other examples, the zipper may have a different length, such as a quarter length zipper. In additional examples, another type of fastener, such as a hook and loop fastener, a snap, a button, and the like may be used instead of or in combination with a zipper.

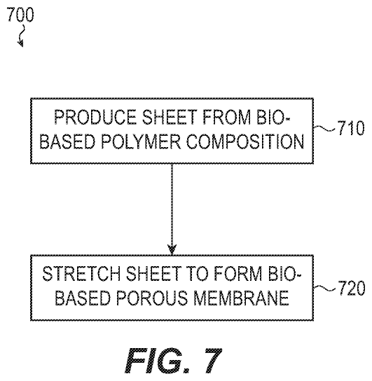

FIG. 7 shows a flow chart of an example process 700 for making a bio-based porous membrane. In some cases, the process 700 is designed to minimize use of solvents. For example, the process 700 relies on a mechanical stretching operation to form the pores of the membrane rather than a solvent-based pore forming operation.

The process 700 includes an operation 710 of producing a sheet from a bio-based polymer composition. As previously discussed with respect to FIG. 1, the bio-based polymer composition may comprise a bio-based polymer material, which may be a bio-based polyolefin material. As a particular example, the bio-based polyolefin material may be a bio-based polyethylene material. In some cases, the bio-based polyethylene material is a product of polymerization of ethylene derived from a plant-based source such as sugar cane. The additional description of bio-based polymer compositions provided with respect to FIG. 1 is applicable to the processes described herein and is not repeated here. The sheet may have a bio-based carbon content greater than 50%, from 60% to 100%, from 60% to 95%, from 70% to 100%, from 70% to 95%, from 80% to 100%, from 80% to 95%, from 85% to 100%, from 90% to 100%, or from 95% to 100%. The sheet may be substantially non-porous and may have a thickness greater than the thickness of the porous membrane to be produced in the operation 720. In some cases, the operation 710 comprises melting the bio-based polymer composition and then forming the sheet using a calendaring process.

The process 700 also includes an operation 720 of stretching the sheet to form a bio-based porous membrane. The operation of stretching the sheet creates pores in the sheet, thereby forming the bio-based porous membrane. The operation of stretching the sheet also reduces its thickness. The sheet may be stretched in multiple directions during the operation 720. In some cases, the operation 720 includes two sequential stretching operations each of which stretches the sheet in a different direction (e.g., a machine direction and a transverse direction). The resulting bio-based membrane may comprise an expanded polymer material, such as an expanded polyolefin material, due to the stretching process.

In additional embodiments, the process 700 may include one or more additional operations. For example, the process 700 may include an operation of making the bio-based polymer composition used in the operation 710.

In additional methods, the bio-based porous membrane may be formed by a different process, such as an electrospinning process. The electrospinning process may form the bio-based porous membrane directly from the bio-based polymer composition.

The disclosure also provides methods for making articles including the bio-based porous membranes described herein. An example method includes laminating the bio-based porous membrane to one or more additional layers. As previously discussed with respect to FIGS. 2 and 3, the one or more additional layers may include a bio-based textile layer, a leather layer, a bio-based polymer layer, or a combination of these. In some cases, the bio-based porous membrane may be laminated to the one or more additional layers using a bio-based adhesive. The additional description previously provided with respect to the layers of the laminate, lamination techniques, and articles including the laminates is generally applicable herein and is not repeated here.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A porous membrane having a bio-based carbon content greater than 50% and including a polyolefin material.

2. The porous membrane of claim 1, wherein the bio-based carbon content ranges from 70% to 95%.

3. The porous membrane of claim 1, wherein the polyolefin material is an expanded polyolefin material.

4. The porous membrane of claim 1, wherein the polyolefin material comprises a polyethylene material.

5. The porous membrane of claim 4, wherein the polyolefin material includes at least 90% by weight of the polyethylene material.

6. The porous membrane of claim 1, wherein the porous membrane is a microporous membrane.

7. The porous membrane of claim 1, wherein pores of the porous membrane are configured to impart a waterproof property to the porous membrane.

8. A laminate having a bio-based carbon content greater than 50% and comprising:
the porous membrane of claim 1 as a first layer; and
a second layer, different from the first layer.

9. The laminate of claim 8, wherein the bio-based carbon content ranges from 60% to 95%.

10. The laminate of claim 8, wherein the second layer is selected from a textile layer, a leather layer, or a polymer layer.

11. The laminate of claim 10, wherein the second layer is a textile layer having a bio-based carbon content greater than 50%.

12. The laminate of claim 11, wherein the textile layer is formed from a bio-based nylon.

13. The laminate of claim 11, further comprising a water repellant agent disposed on the textile layer and the water repellant agent is substantially free of fluorinated compounds.

14. The laminate of claim 11, wherein the laminate further comprises a third layer that is second textile layer having a bio-based carbon content greater than 50% and the porous membrane is positioned between the first textile layer and the second textile layer.

15. The laminate of claim 8, further comprising a bio-based adhesive bonding the first layer to the second layer.

16. An article of apparel comprising the laminate of claim 8.

17. The article of claim 16, wherein the article is a shoe.

18. A method for manufacturing a bio-based porous membrane, the method comprising:
producing a sheet from a polymer composition having a bio-based carbon content greater than 50% and including a polyolefin material; and
stretching the sheet to form the bio-based porous membrane.

19. The method of claim 18, wherein the polymer composition includes greater than or equal to 90% by weight of the polyolefin material.

20. The method of claim 18, wherein the polyolefin material is a polyethylene material.
